(19) United States
(12) Patent Application Publication
(10) Pub. No.: US 2026/0097435 A1
(43) Pub. Date: Apr. 9, 2026

(54) MULTI-SIZE BIT HOLDER FOR A ROTARY POWER TOOL

(71) Applicant: MILWAUKEE ELECTRIC TOOL CORPORATION, Brookfield, WI (US)

(72) Inventor: Nathan D. Hankins, Caledonia, WI (US)

(21) Appl. No.: 19/352,113

(22) Filed: Oct. 7, 2025

Related U.S. Application Data
(60) Provisional application No. 63/704,358, filed on Oct. 7, 2024.

(51) Int. Cl. B23B 31/171; B25B 23/00

(52) U.S. Cl. CPC B23B 31/16125; B25B 23/0035

(57) ABSTRACT

A bit holder for a rotary power tool includes a body rotatable about a central axis, the body including a bit aperture configured to receive a tool bit, a collar surrounding the body, the collar rotatable with respect to the body about the central axis, the collar including a first cam profile and a second cam profile, and a plurality of jaws rotatably coupled to the body such that each jaw of the plurality of jaws is rotatable about a jaw axis, each jaw of the plurality of jaws including a first cam arm configured to engage and move along the first cam profile and a second cam arm configured to engage and move along the second cam profile.

### CROSS-REFERENCE TO RELATED APPLICATIONS

This application claims priority to U.S. Provisional Patent Application No. 63/704,358, filed October 7, 2024, the entire content of which is incorporated herein by reference.

### FIELD

The present disclosure relates to power tools, and more particularly to bit holders for rotary power tools.

### BACKGROUND

Rotary power tools commonly employ standardized bits (e.g., hex-shanked bits) for positive torque transmission to perform tasks such as drilling or fastening. Conventional quick-change bit holders typically rely on (i) magnetic retention, (ii) spring-biased ball-detent sleeves engaging an annular groove on the shank, or (iii) collet/chuck mechanisms actuated by a sliding or rotating collar. While such approaches are serviceable for a single nominal shank size (e.g., 1/4-inch hex), practical limitations arise when multiple nominal sizes are to be accommodated in compact, high-torque or impact applications. Magnetic retention can permit gradual axial walk-out under impact loads and tends to attract ferrous debris; ball-detent systems apply localized point contacts that provide limited radial centering and are sensitive to groove depth, wear, and contamination; and general-purpose chucks that span different sizes often trade compactness and one-handed operation for range, with increased runout and inconsistent clamping forces. Tolerance spreads in bit shanks can produce angular play (wobble) or excessive insertion force, and multi-size implementations may lack discrete, repeatable locked states correlated with the intended shank sizes, leading to uncertain user feedback and variable retention performance. Additionally, small clearances are susceptible to dust, chips, and oils that impede motion over the service life, and achieving predictable retention across sizes can demand tight manufacturing tolerances and numerous fitted parts.

### SUMMARY

Accordingly, there is a need for a compact, quick-change bit holder that reliably receives and retains standard hex-shanked bits of different nominal sizes with repeatable, discrete locked positions that promote low runout and robust axial and torsional retention, in some cases under impact loads, while enabling simple (preferably one-handed) operation and maintaining performance in the presence of wear and typical workshop contaminants.

The present disclosure provides, among other things, a bit holder for rotary power tools that affords consistent and reliable retention and centering of standard hex-shanked bits across multiple nominal sizes within a compact form factor and with straightforward operation, particularly under the torque and/or impact conditions encountered in use.

For example, in some aspects, the techniques described herein relate to a bit holder for a rotary power tool, the bit holder including: a body rotatable about a central axis, the body including a bit aperture configured to receive a tool bit; a collar surrounding the body, the collar rotatable with respect to the body about the central axis, the collar including a first cam profile and a second cam profile; and a plurality of jaws rotatably coupled to the body such that each jaw of the plurality of jaws is rotatable about a jaw axis, each jaw of the plurality of jaws including a first cam arm configured to engage and move along the first cam profile and a second cam arm configured to engage and move along the second cam profile.

In some aspects, the techniques described herein relate to a bit holder, wherein each jaw of the plurality of jaws includes a tool engaging surface configured to contact the tool bit.

In some aspects, the techniques described herein relate to a bit holder, wherein each jaw of the plurality of jaws includes a projecting rib extending from the tool engaging surface and configured to engage an end of a groove formed in the tool bit to axially retain the tool bit.

In some aspects, the techniques described herein relate to a bit holder, wherein the tool engaging surface and a line intersecting the jaw axis and a contact point where the first cam arm engages the first cam profile define an included angle between 30 degrees and 60 degrees.

In some aspects, the techniques described herein relate to a bit holder, wherein the first cam arm has a first length, the second cam arm has a second length greater than the first length, and wherein the first cam profile is disposed radially inwardly relative to the second cam profile.

In some aspects, the techniques described herein relate to a bit holder, wherein the collar is rotatable in a tightening direction and a release direction, and wherein rotation of the collar in the tightening direction causes the first cam profile to bear against the first cam arm of each jaw to pivot the jaw about the jaw axis in the tightening direction.

In some aspects, the techniques described herein relate to a bit holder for a rotary power tool, the bit holder including: a body rotatable about a central axis, the body including a bit aperture configured to receive a tool bit; a plurality of jaws rotatably coupled to the body such that each jaw of the plurality of jaws is rotatable about a jaw axis parallel to the central axis, each jaw of the plurality of jaws including a cam arm; and a collar surrounding the body, the collar is rotatable with respect to the body about the central axis in a tightening direction to retain the tool bit and a release direction to permit removal of the tool bit, the collar defining a cam profile engageable with the cam arm of each jaw such that rotation of the collar in the tightening direction causes the cam profile to bear against the cam arm of each jaw to pivot the jaw about the jaw axis in the tightening direction.

In some aspects, the techniques described herein relate to a bit holder, further including a spring biasing the collar in the tightening direction.

In some aspects, the techniques described herein relate to a bit holder, wherein each jaw of the plurality of jaws includes a tool engaging surface configured to contact the tool bit, and wherein rotation of the jaw about the jaw axis in the tightening direction causes the tool engaging surface to move toward the central axis.

In some aspects, the techniques described herein relate to a bit holder, wherein a biasing torque applied to the collar by the spring is capable of generating between 5 lbs. and 30 lbs. of clamping force on the tool bit.

In some aspects, the techniques described herein relate to a bit holder, wherein the cam profile includes a plurality of ridges, and wherein the cam arm of each jaw is engageable with a respective one of the plurality of ridges to retain the collar in an unlocked position against the biasing torque of the spring.

In some aspects, the techniques described herein relate to a bit holder, wherein the cam profile includes a plurality of ridges, and wherein the cam arm of each jaw is engageable with a respective one of the plurality of ridges to retain the collar in an unlocked position against the biasing torque of the spring.

In some aspects, the techniques described herein relate to a bit holder, wherein the spring is a torsion spring.

In some aspects, the techniques described herein relate to a bit holder, wherein the tool bit is a first tool bit having a hexagonal shank of a first standard size.

In some aspects, the techniques described herein relate to a bit holder, wherein the bit holder is configured to selectively receive and secure a second tool bit having a hexagonal shank of a second standard size larger than the first standard size, and to selectively receive and secure a third tool bit having a hexagonal shank of a third standard size larger than the second standard size.

In some aspects, the techniques described herein relate to a bit holder for a rotary power tool, the bit holder including: a body rotatable about a central axis, the body including a bit aperture configured to receive a tool bit; a plurality of jaws rotatably coupled to the body such that each jaw of the plurality of jaws is rotatable about a jaw axis parallel to the central axis; a collar surrounding the body, the collar is rotatable with respect to the body about the central axis in a tightening direction to retain the tool bit and a release direction to permit removal of the tool bit; and a spring biasing the collar in the tightening direction, wherein rotation of the collar in the tightening direction causes each jaw to pivot about the jaw axis in the tightening direction, and wherein rotation of the collar in the release direction causes each jaw to pivot about the jaw axis in the release direction.

In some aspects, the techniques described herein relate to a bit holder, wherein each jaw of the plurality of jaws includes a tool engaging surface configured to contact the tool bit, and wherein rotation of the jaw about the jaw axis in the tightening direction causes the tool engaging surface to move toward the central axis.

In some aspects, the techniques described herein relate to a bit holder, wherein a biasing torque applied to the collar by the spring is capable of generating between 5 lbs. and 30 lbs. of clamping force on the tool bit.

In some aspects, the techniques described herein relate to a bit holder, wherein each jaw of the plurality of jaws includes a rib extending from the tool engaging surface, the rib configured to be received in a groove formed in the tool bit.

In some aspects, the techniques described herein relate to a bit holder, wherein each jaw of the plurality of jaws defines a second-class lever.

Other aspects of the disclosure will become apparent by consideration of the detailed description and accompanying drawings.

### BRIEF DESCRIPTION OF THE DRAWINGS

FIG. 1 is a perspective view of a bit holder according to an embodiment of the disclosure.

FIG. 2 is a perspective view of an exemplary tool bit that can be retained by the bit holder of FIG. 1.

FIG. 3 is a diagram illustrating three different nominal sizes of shanks that may be used on tool bits, such as the tool bit of FIG. 2, and retained by the bit holder of FIG. 1.

FIG. 4A is a front view of a jaw of the bit holder of FIG. 1.

FIG. 4B is a rear view of a jaw of the bit holder of FIG. 1.

FIG. 4C is a rear section view along line 4C-4C of the bit holder of FIG. 1.

FIG. 5A is a front section view along a line 5A-5A of the bit holder of FIG. 1 in a released position.

FIG. 5B is a rear section view along a line 5B-5B of the bit holder of FIG. 1 in the released position.

FIG. 6A is a front section view along the line 5A-5A of the bit holder of FIG. 1 in a first position.

FIG. 6B is a rear section view along the line 5B-5B of the bit holder of FIG. 1 in the first position.

FIG. 7A is a front section view along the line 5A-5A of the bit holder of FIG. 1 in a second position.

FIG. 7B is a rear section view along the line 5B-5B of the bit holder of FIG. 1 in the second position.

FIG. 8A is a front section view along the line 5A-5A of the bit holder of FIG. 1 in a third position.

FIG. 8B is a rear section view along the line 5B-5B of the bit holder of FIG. 1 in the third position.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

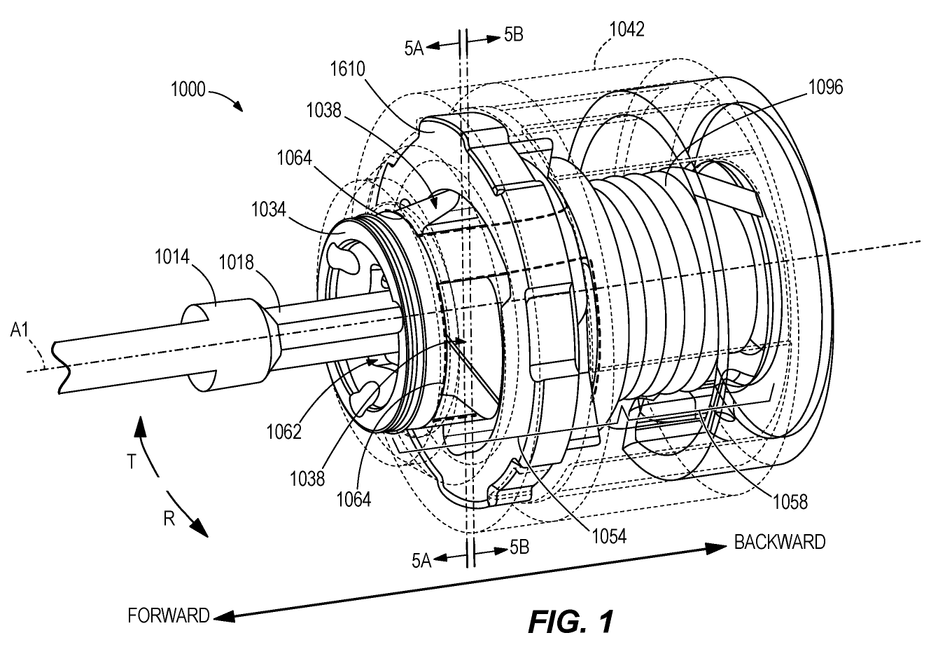

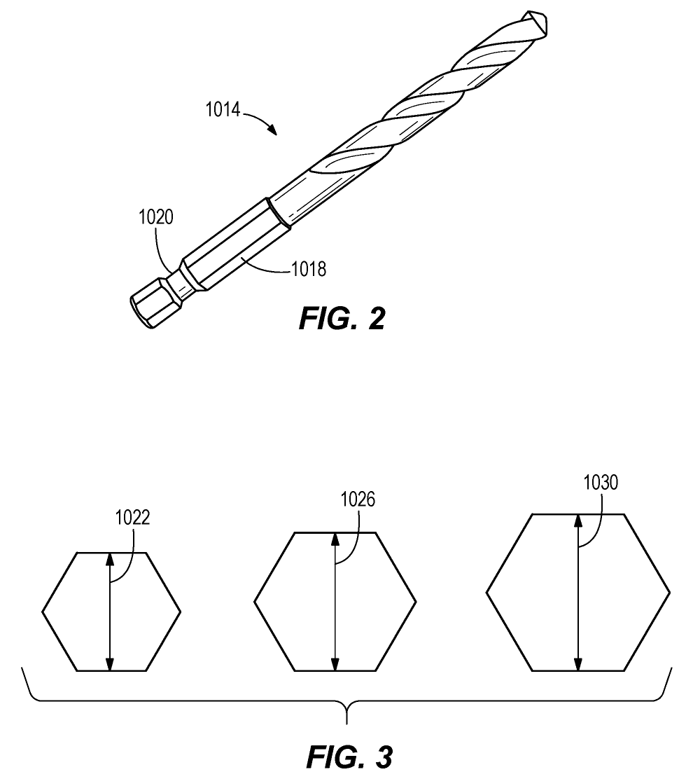

FIG. 1 illustrates a bit holder 1000 (which may also be referred to as a chuck) configured to hold tool bits, according to an embodiment of the present disclosure. The bit holder 1000 may be connected to an output member (e.g., a spindle, an anvil, etc.; not shown) of a rotary power tool (e.g., a drill, impact driver, etc.; not shown). The illustrated bit holder 1000 is configured to quickly receive and secure tool bits with standardized shanks of at least two different predetermined, nominal sizes. For example, the illustrated bit holder 1000 is configured to receive a tool bit 1014 with a hexagonal shank 1018 that can be any one of a first nominal size 1022, a second nominal size 1026, and a third nominal size 1030 (FIGS. 2 and 3). The first, second, and third nominal sizes 1022, 1026, 1030 are preferably standard or commonly used hexagonal shank sizes, such as 1/4-inch, 3/8-inch, and 7/16-inch. The bit holder 1000 may be configured to receive tool bits with other types of shanks (e.g., square, three-flat, round, etc.). In addition, the bit holder 1000 may be configured to receive tool bits of four or more different nominal shank sizes. The hexagonal shank 1018 further includes a groove 1020 configured to engage a portion of the bit holder 1000 to limit axial movement.

With reference to FIG. 1, the bit holder 1000 includes a body 1034, a plurality of jaws 1038, and a collar 1042. The illustrated bit holder 1000 also includes a spring, such as a torsion spring 1096. The body 1034 is coupled for co-rotation with the output member of the power tool about a central axis A1. The body 1034 may be secured to the output member via a press-fit, one or more fasteners, or any other suitable torque-transferring arrangement. In some embodiments, the body 1034 may be an integral portion of the output member of the power tool.

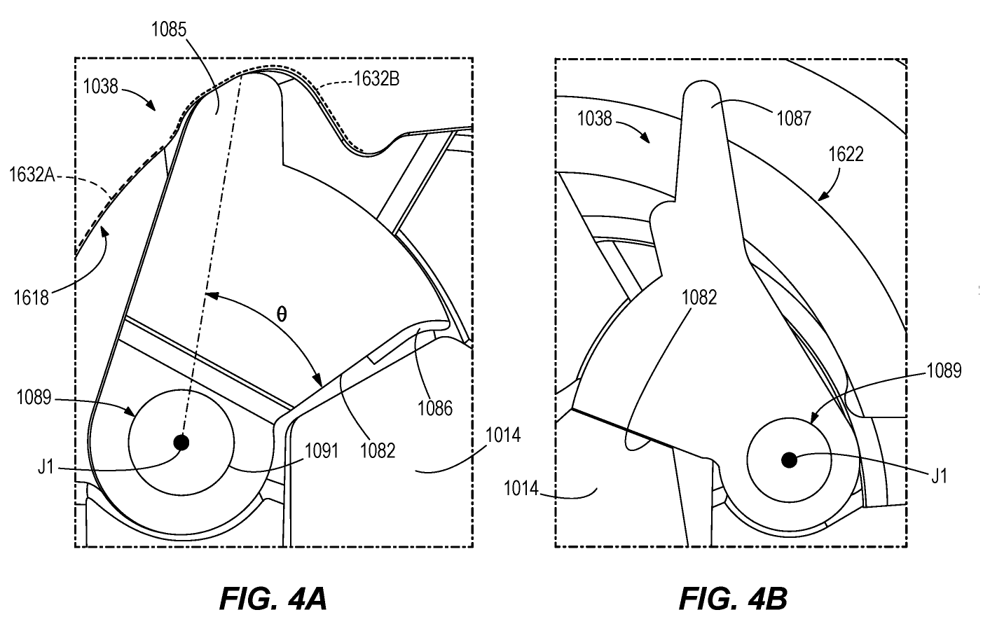

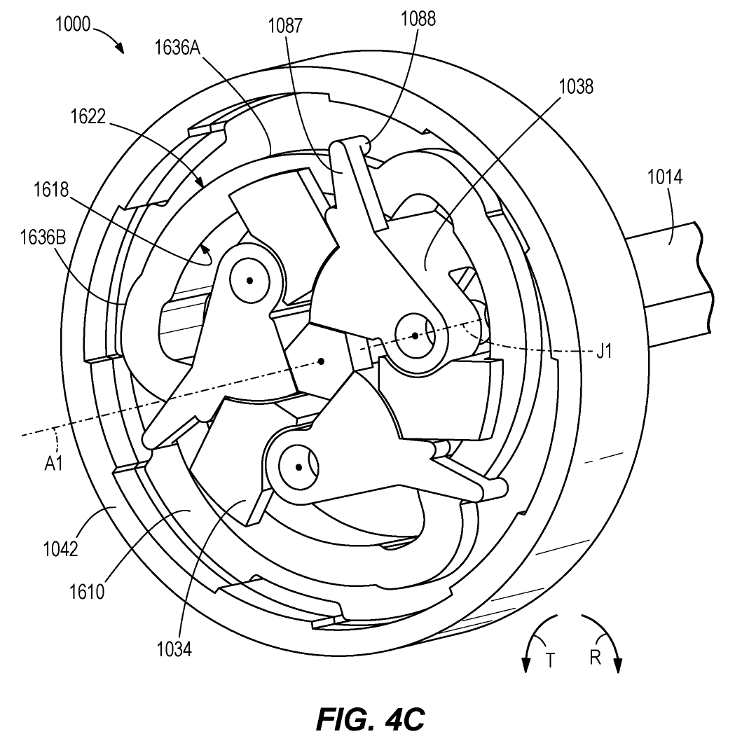

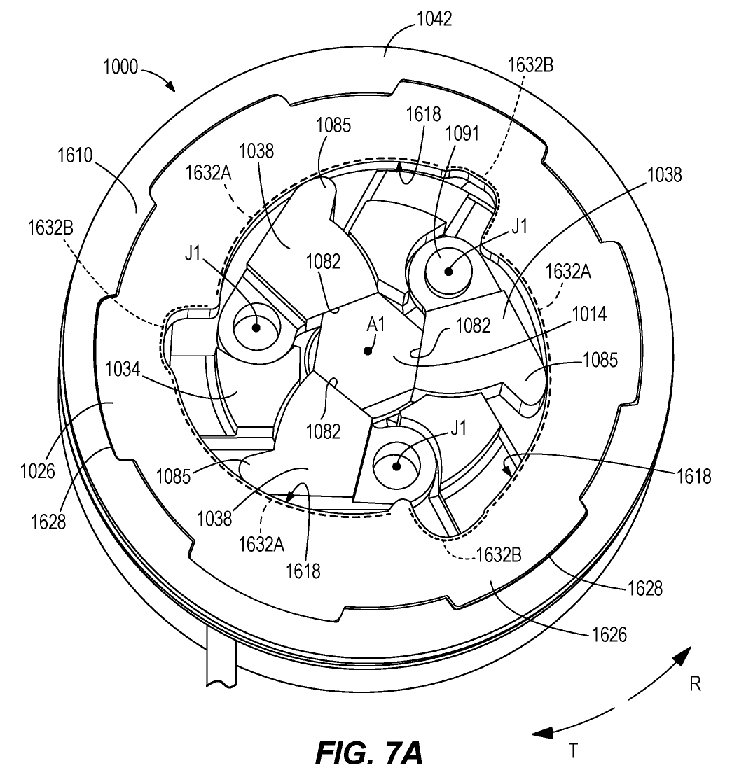

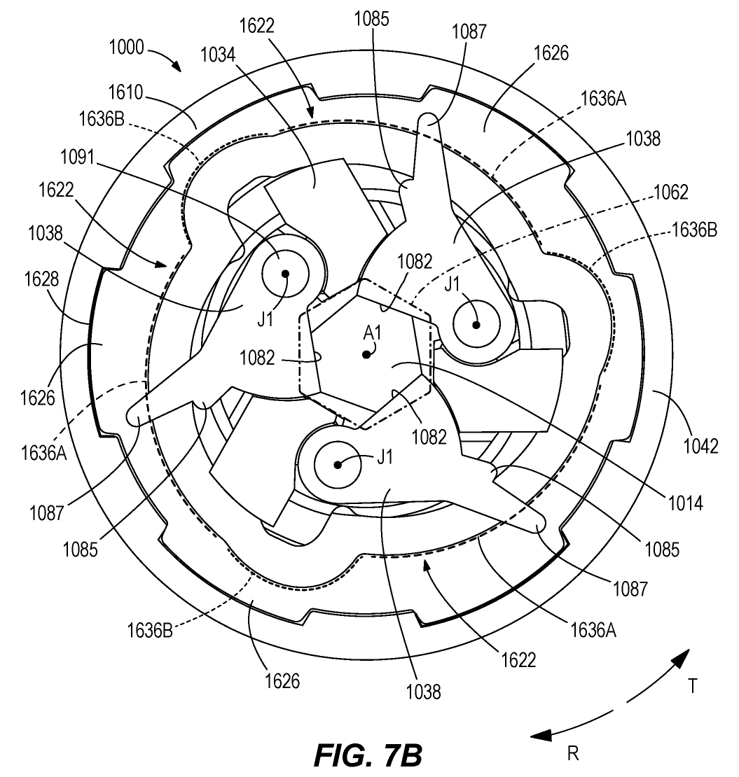

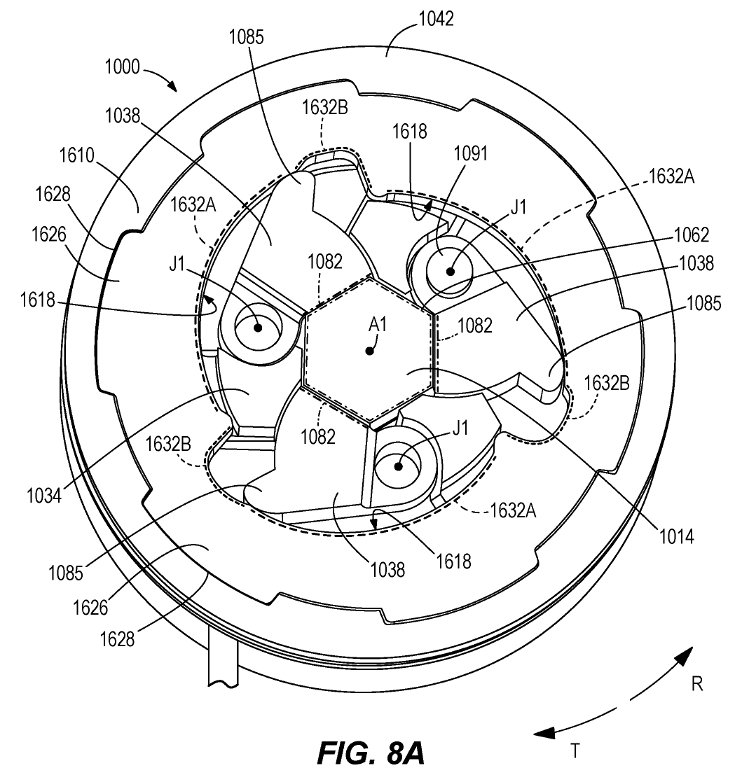

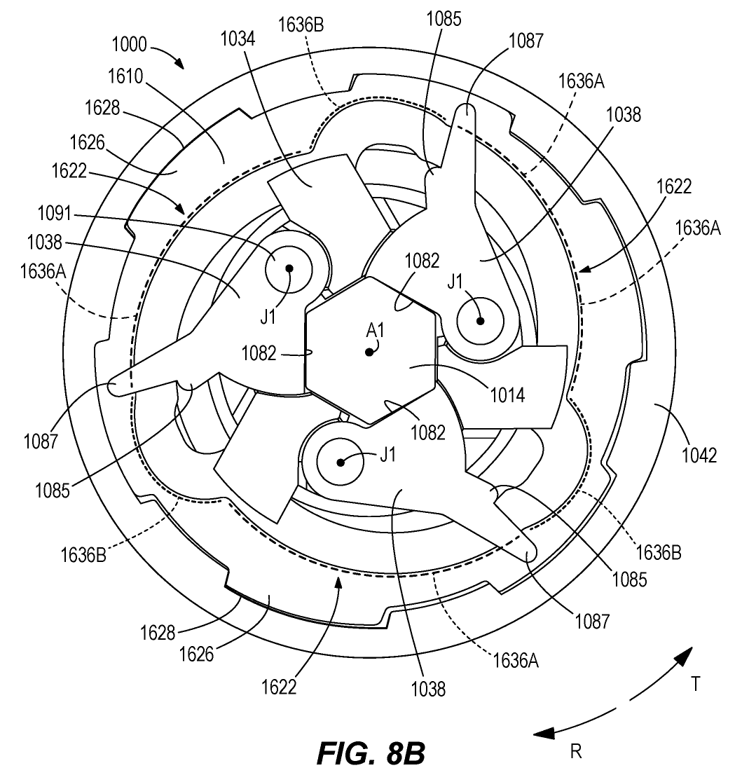

The jaws 1038 are configured to engage the shank 1018 of the tool bit 1014 to couple the tool bit 1014 for co-rotation with the body 1034. The illustrated bit holder 1000 includes three jaws 1038 (best illustrated in FIGS. 4C-8B); however, the bit holder 1000 may include other numbers of jaws 1038 in other embodiments. As described in greater detail below, the collar 1042 is selectively rotatable about the central axis A1 in a release direction R (e.g., counterclockwise when viewed from a front to rear direction) and a tightening direction T (e.g., clockwise when viewed from a front to rear direction) in order to release or retain the tool bit 1014 within the bit holder 1000. The torsion spring 1096 is configured to apply a biasing torque to the collar 1042 to bias the collar 1042 in the tightening direction T.

With reference to FIG. 1, the body 1034 includes a head portion 1054 and a shaft portion 1058. The head portion 1054 includes a tool bit aperture 1062 configured to receive the tool bit 1014 and a plurality of openings 1064 disposed circumferentially about the head portion 1054. In the illustrated embodiment, the tool bit aperture 1062 is hexagonally shaped in a plane perpendicular to the axis A1, but in other embodiments the tool bit aperture 1062 can be square, triangular, round, etc. Each of the openings 1064 extends into the tool bit aperture 1062 and receives a corresponding one of the jaws 1038 such that each jaw 1038 is configured to rotate and extend into or out of the tool bit aperture 1062. The shaft portion 1058 may include threads to engage the output member of the rotary tool, but in other embodiments other connection methods can be used (e.g., a spline, press fit, mechanical fasteners, etc.) to couple the body 1034 to the output member of the power tool for co-rotation.

With reference to FIGS. 4A-4B, each jaw 1038 includes a tool engaging surface 1082, a first cam arm 1085, a second cam arm 1087. The tool engaging surface 1082 is configured to engage the shank 1018 of the tool bit 1014. In the illustrated embodiment, a projecting rib 1086 extends from the tool engaging surface 1082 to engage an end of the groove 1020 of the tool bit 1014 to axially retain the tool bit 1014. The first cam arm 1085 is configured to engage an inner cam profile 1618 (i.e., a first cam profile) of a cam insert 1610, which may be a portion of the collar 1042 or a component coupled for co-rotation with the collar 1042, to guide the movement of the jaw 1038. Best illustrated in FIG. 4C, the second cam arm 1087 includes a post 1088 at its distal end, which is configured to engage an outer cam profile 1622 (i.e., a second cam profile) of the cam insert 1610 and guide the movement of the jaw 1038.

Each of the illustrated jaws 1038 further includes a fastener opening 1089 that receives a fastener 1091 to rotatably couple the jaw 1038 to the body 1034. The fastener opening 1089 (and the fastener 1091) define a jaw axis J1, about which the jaw 1038 rotates. In the illustrated embodiment, the fastener 1091 is a pin pressed into the fastener opening 1089. In other embodiments, the fastener 1091 may be a bolt, a rivet, or the like. In the illustrated embodiment, the jaw axis J1 of each jaw 1038 is parallel to the central axis A1. In some embodiments, a plane defined by the tool engaging surface 1082 does not intersect the jaw axis J1.

Referring to FIG. 4A, an included angle θ is defined between the tool engaging surface 1082 and a line extending from the jaw axis J1 to a contact point where the first cam arm 1085 engages the inner cam profile 1618. The angle θ may be, for example, between 40 degrees and 55 degrees in some embodiments. In other embodiments, the angle θ may be between 30 degrees and 52 degrees. In other embodiments, the angle θ may be between 20 degrees and 60 degrees. The angle θ may vary (e.g., within the ranges described above) in a particular embodiment depending on a position of the jaw 1038, since the point of contact between the first cam arm 1085 and the inner cam profile 1618 may vary depending on a position of the jaw 1038.

As shown in FIGS. 1 and 5A-8B, the collar 1042 surrounds the body 1034 and is rotatable with respect to the body 1034 around the central axis A1. The illustrated cam insert 1610 is positioned within the collar 1042. The cam insert 1610 includes a plurality of protrusions 1626, the inner cam profile 1618, and the outer cam profile 1622. The protrusions 1626 are formed on an outer circumferential surface of the cam insert 1610 and are received in a plurality of recesses 1628 formed in the collar 1042. The cam insert 1610 is coupled for co-rotation with the collar 1042 by the engagement of the protrusions 1626 and recesses 1628 and is axially fixed to the collar 1042.

With reference to FIGS. 4C, 5A, 6A, 7A, and 8A, the inner cam profile 1618 is disposed radially inwardly relative to the outer cam profile 1622. Accordingly, in the illustrated embodiment, the first cam arm 1085 has a first length, and the second cam arm 1087 has a second length greater than the first length. In the illustrated embodiment, the inner cam profile 1618 includes three inner cam profile portions corresponding with the number of jaws 1038. In other embodiments, the number of inner cam profile portions may include a greater or fewer number of cam profile portions. Each portion of the illustrated inner cam profile 1618 includes an inward-facing cam surface that is configured to engage the first cam arm 1085 of a respective one of the jaws 1038 and includes a tightening portion 1632A that gradually increases to a first maximum radius from the axis A1 and a release portion 1632B having a second maximum radius from the axis A2. In the illustrated embodiment, the first maximum radius is less than the second maximum radius.

When the first cam arms 1085 of the jaws 1038 engage the tightening portions 1632A of the first cam profile 1618, the jaws 1038 extend into the tool bit aperture 1062 to engage the installed tool bit 1014. In some embodiments, the locked portions 1632A include notches or protrusions to maintain the first cam arm 1085 in a specific position of the locked portion 1632A, which in turn would keep the jaw 1038 in a specific position in the tool bit aperture 1062. When the first cam arms 1085 move to the release portions 1632B, the jaws 1038 are withdrawn from the tool bit aperture 1062 to permit the installed tool bit 1014 to be removed and a new tool bit 1014 inserted. In some embodiments, a protrusion or a region of a different texture from the remainder of the inner cam profile 1618 may be formed in between the tightening portion 1632A and the release portion 1632B to indicate to a user (by tactile feedback) the transition between the tightening and release portions 1632A, 1632B of the first cam profile 1618.

With reference to FIGS. 4C, 5B, 6B, 7B, and 8B, the outer cam profile 1622 is formed on the rear side of cam insert 1610. In the illustrated embodiment, the outer cam profile 1622 includes three outer cam profile portions corresponding with the number of jaws 1038. In other embodiments, the number of outer cam profile portions may be greater than or less than three. Each portion of the illustrated outer cam profile 1622 includes an outward facing cam surface that is configured to engage the post 1088 (FIG. 4C) on the second cam arm 1087 of a respective one of the jaws 1038. Each portion of the outer cam profile 1622 includes a tightening portion 1636A that gradually increases to a first maximum radius and a release portion 1636B having a second maximum radius. In the illustrated embodiment, the first maximum radius is less than the second maximum radius. When the second cam arms 1087 of the jaws 1038 engage the tightening portions 1636A, the jaws 1038 extend into the tool bit aperture 1062 to engage the tool bit 1014. In some embodiments, the tightening portions 1636A include notches or protrusions to maintain the posts 1088 of the second cam arms 1087 in a specific position of the tightening portion 1636A, which in turn would keep the jaw 1038 in a specific position in the tool bit aperture 1062. When the posts 1088 of the second cam arms 1087 are moved to the release portions 1636B, the jaws 1038 are withdrawn from the tool bit aperture 1062 to permit the installed tool bit 1014 to be removed and a new tool bit 1014 inserted. In some embodiments, a protrusion or a region of a different texture from the remainder of the outer cam profile 1622 may be formed in between the tightening portion 1636A and the release portion 1636B to indicate to a user (by tactile feedback) the transition between the tightening and release portions 1636A, 1636B.

With reference to FIG. 1, the torsion spring 1096 is positioned on the body 1034 and surrounds the shaft portion 1058 of the body 1034. The torsion spring 1096 includes a first leg coupled to the body 1034 and a second leg coupled to the collar 1042. In use, the torsion spring 1096 applies a biasing torque to rotate the collar 1042 around the central axis A1 relative to the collar 1042. Additionally, the biasing torque of the torsion spring 1096 presses the jaws 1038 to grip the tool bit 1014, as described in greater detail below. The biasing torque applied by the torsion spring 1096 is amplified by the mechanical advantage provided by the cam profiles 1618, 1622 and by the jaws 1038 themselves, which define second-class levers (with the ends of the cam arms 1085, 1087 located further from the jaw axis J1 than the tool engaging surface 1082). In some embodiments, the biasing torque applied by the torsion spring 1096 may generate 5 to 30 lbs. of clamping force on the tool bit 1014. In some embodiments, the biasing torque applied by the torsion spring 1096 may generate 10 to 25 lbs. of clamping force on the tool bit 1014. In some embodiments, the biasing torque applied by the torsion spring 1096 may generate 15 to 25 lbs. of clamping force on the tool bit 1014. This relatively high clamping force is able to effectively secure the tool bit 1014 and can be achieved with a relatively small biasing torque, such that the collar 1042 can still be rotated by a user with one hand.

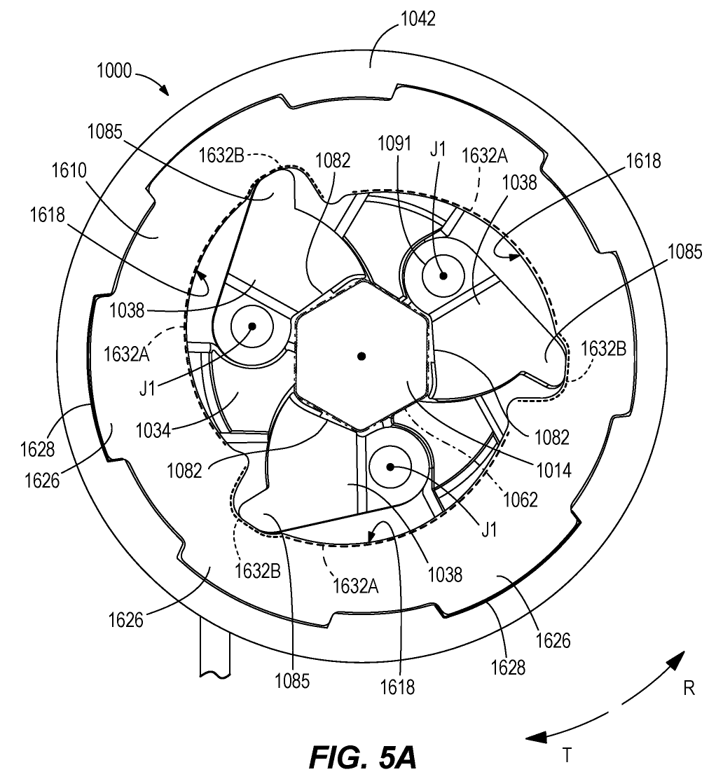

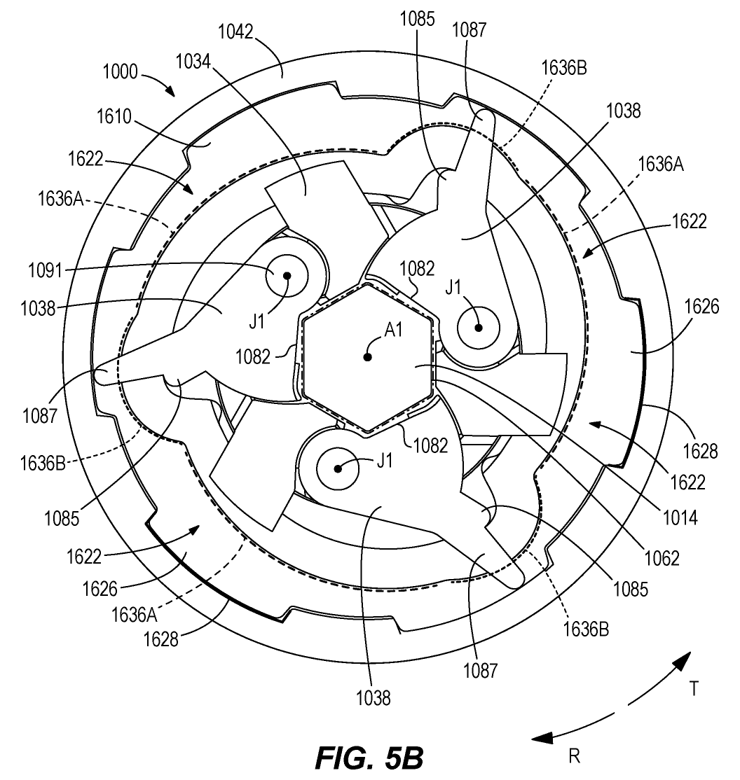

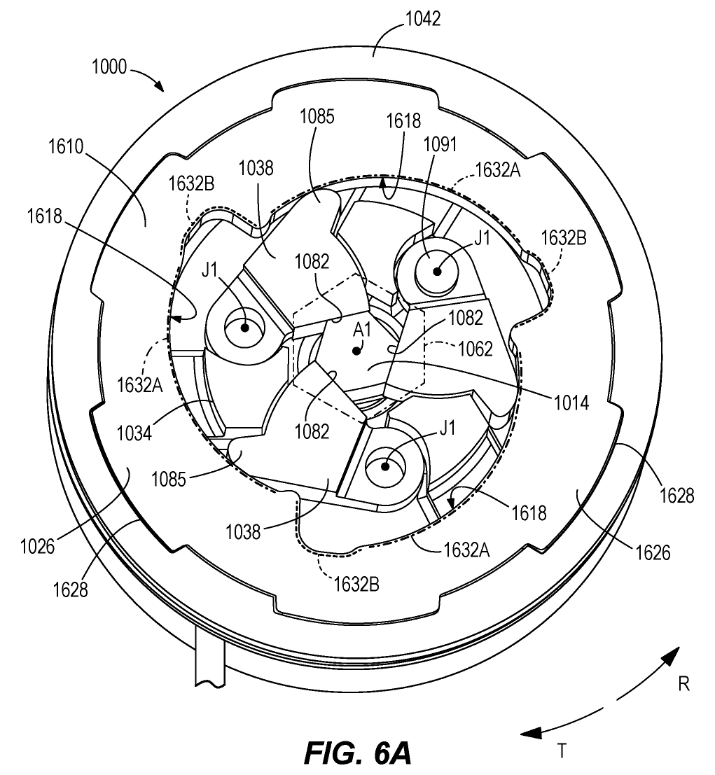

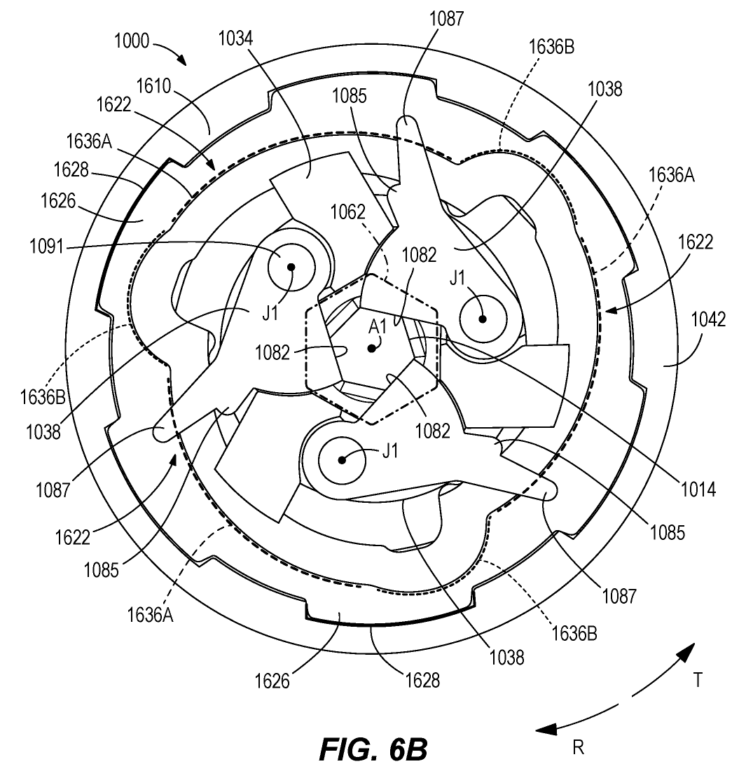

The bit holder 1000 is moveable between an unlocked position (FIGS. 5A-B) and a plurality of distinct locked positions (FIGS. 6A-8B). In the unlocked position, the jaws 1038 are retracted from the tool bit aperture 1062, and the tool engaging surfaces 1082 of the jaws 1038 do not engage the tool bit 1014. As a result, the tool bit 1014 may be removed from the tool bit aperture 1062 with minimal resistance, or a tool bit 1014 smaller than the tool bit aperture 1062 may be installed. Each locked position of the bit holder 1000 corresponds to one of the nominal sizes 1022, 1026, and 1030 of the tool bits 1014. In any of the locked positions (FIGS. 6A-8B), the jaws 1038 are either in line with or extend into the tool bit aperture 1062. As a result, the tool engaging surface 1082 contacts the installed tool bit 1014, which creates resistance when removing the tool bit 1014.

In use, the operator will first transition the bit holder 1000 into the unlocked position, as shown in FIGS. 5A-5B. Initially, the operator will grasp the outer surface of the collar 1042, rotate the collar 1042 in the release direction R relative to the body 1034, and overcome the biasing torque applied by the torsion spring 1096. Simultaneously, the cam insert 1610 of the collar 1042 also rotates in the same direction. As a result, the inner cam profile 1618 and the outer cam profile 1622 are rotated relative to the jaws 1038, and the first cam arms 1085 and the second cam arms 1087 move from the tightening portions 1632A, 1636A toward the release portions 1632B, 1636B. As the posts 1088 of the second cam arms 1087 ride along the outer cam profile 1622, the jaws 1038 pivot in the release direction R about their respective jaw axes J1. (FIG. 4C). The pivoting movement of the jaws 1038 causes the tool engaging surfaces 1082 to move radially outward away from the center axis A1 and out of the tool bit aperture 1062 (FIGS. 5A-5B). Once the cam arms 1085, 1087 reach the release portions 1632B, 1636B, protrusions or ridges between adjacent tightening portions 1632A, 1636A and release portions 1632B, 1636B engage the cam arms 1085, 1087 to provide resistance sufficient to retain the collar 1042 in the unlocked position. Now, the operator may remove the installed tool bit 1014 if present, and the collar 1042 will remain in the unlocked position even if the operator releases the collar 1042.

Next, the operator inserts a desired tool bit 1014 into the tool bit aperture 1062. The operator then applies an initial force to the collar 1042 in the tightening direction T to move the cam arms 1085, 1087 over the ridges and on to the tightening portions 1632A, 1636A. The collar 1042 may then be released, and the biasing torque of the torsion spring 1096 rotates the collar 1042 in the tightening direction T. Simultaneously, the cam insert 1610 is also rotated in the same direction T. As a result, the plurality of inner cam profile 1618 and the outer cam profile 1622 are rotated relative to the jaws 1038. Rotation of the inner cam profile 1618 causes the first cam arms 1085 to move along the tightening portions 1632A, which forces the jaws 1038 to pivot about their respective jaw axes J1 in the tightening direction T, until the tool engaging surface 1082 of each jaw 1038 contacts the tool bit 1014.

Depending on the size of the tool bit 1014, the jaws 1038 may stop in one of the three locations shown in FIGS. 5A-8B. In other embodiments, the jaws 1038 may stop in positions other than those shown in FIGS. 5A-5B. When the tool engaging surface 1082 of the jaw 1038 contacts the tool bit 1014, the projecting rib 1086 of the jaws 1038 also extends into the groove 1020 of the tool bit 1014 to axially retain the tool bit 1014 in the tool bit aperture 1062. The tool bit 1014 is now secured in tool bit aperture 1062 of the bit holder 1000.

Various features and aspects of the present disclosure are set forth in the following claims. When used in this specification and claims, the terms “comprises” and “comprising” and variations thereof mean that the specified features, steps or integers are included. The terms are not to be interpreted to exclude the presence of other features, steps or components.

What is claimed is:

1. A bit holder for a rotary power tool, the bit holder comprising:
a body rotatable about a central axis, the body including a bit aperture configured to receive a tool bit;
a collar surrounding the body, the collar rotatable with respect to the body about the central axis, the collar including a first cam profile and a second cam profile; and
a plurality of jaws rotatably coupled to the body such that each jaw of the plurality of jaws is rotatable about a jaw axis, each jaw of the plurality of jaws including a first cam arm configured to engage and move along the first cam profile and a second cam arm configured to engage and move along the second cam profile.

2. The bit holder of claim 1, wherein each jaw of the plurality of jaws includes a tool engaging surface configured to contact the tool bit.

3. The bit holder of claim 2, wherein each jaw of the plurality of jaws includes a projecting rib extending from the tool engaging surface and configured to engage an end of a groove formed in the tool bit to axially retain the tool bit.

4. The bit holder of claim 2, wherein the tool engaging surface and a line intersecting the jaw axis and a contact point where the first cam arm engages the first cam profile define an included angle between 30 degrees and 60 degrees.

5. The bit holder of claim 1, wherein the first cam arm has a first length, the second cam arm has a second length greater than the first length, and wherein the first cam profile is disposed radially inwardly relative to the second cam profile.

6. The bit holder of claim 1, wherein the collar is rotatable in a tightening direction and a release direction, and wherein rotation of the collar in the tightening direction causes the first cam profile to bear against the first cam arm of each jaw to pivot the jaw about the jaw axis in the tightening direction.

7. A bit holder for a rotary power tool, the bit holder comprising:
a body rotatable about a central axis, the body including a bit aperture configured to receive a tool bit;
a plurality of jaws rotatably coupled to the body such that each jaw of the plurality of jaws is rotatable about a jaw axis parallel to the central axis, each jaw of the plurality of jaws including a cam arm; and
a collar surrounding the body, the collar is rotatable with respect to the body about the central axis in a tightening direction to retain the tool bit and a release direction to permit removal of the tool bit, the collar defining a cam profile engageable with the cam arm of each jaw such that rotation of the collar in the tightening direction causes the cam profile to bear against the cam arm of each jaw to pivot the jaw about the jaw axis in the tightening direction.

8. The bit holder of claim 7, further comprising a spring biasing the collar in the tightening direction.

9. The bit holder of claim 8, wherein each jaw of the plurality of jaws includes a tool engaging surface configured to contact the tool bit, and wherein rotation of the jaw about the jaw axis in the tightening direction causes the tool engaging surface to move toward the central axis.

10. The bit holder of claim 9, wherein a biasing torque applied to the collar by the spring is capable of generating between 5 lbs. and 30 lbs. of clamping force on the tool bit.

11. The bit holder of claim 10, wherein the cam profile includes a plurality of ridges, and wherein the cam arm of each jaw is engageable with a respective one of the plurality of ridges to retain the collar in an unlocked position against the biasing torque of the spring.

12. The bit holder of claim 8, wherein the cam profile includes a plurality of ridges, and wherein the cam arm of each jaw is engageable with a respective one of the plurality of ridges to retain the collar in an unlocked position.

13. The bit holder of claim 8, wherein the spring is a torsion spring.

14. The bit holder of claim 7, wherein the tool bit is a first tool bit having a hexagonal shank of a first standard size.

15. The bit holder of claim 14, wherein the bit holder is configured to selectively receive and secure a second tool bit having a hexagonal shank of a second standard size larger than the first standard size, and to selectively receive and secure a third tool bit having a hexagonal shank of a third standard size larger than the second standard size.

16. A bit holder for a rotary power tool, the bit holder comprising:
a body rotatable about a central axis, the body including a bit aperture configured to receive a tool bit;
a plurality of jaws rotatably coupled to the body such that each jaw of the plurality of jaws is rotatable about a jaw axis parallel to the central axis;
a collar surrounding the body, the collar is rotatable with respect to the body about the central axis in a tightening direction to retain the tool bit and a release direction to permit removal of the tool bit; and
a spring biasing the collar in the tightening direction,
wherein rotation of the collar in the tightening direction causes each jaw to pivot about the jaw axis in the tightening direction, and
wherein rotation of the collar in the release direction causes each jaw to pivot about the jaw axis in the release direction.

17. The bit holder of claim 16, wherein each jaw of the plurality of jaws includes a tool engaging surface configured to contact the tool bit, and wherein rotation of the jaw about the jaw axis in the tightening direction causes the tool engaging surface to move toward the central axis.

18. The bit holder of claim 17, wherein a biasing torque applied to the collar by the spring is capable of generating between 5 lbs. and 30 lbs. of clamping force on the tool bit.

19. The bit holder of claim 18, wherein each jaw of the plurality of jaws includes a rib extending from the tool engaging surface, the rib configured to be received in a groove formed in the tool bit.

20. The bit holder of claim 18, wherein each jaw of the plurality of jaws defines a second-class lever.
